(19) United States
(12) Patent Application Publication
(10) Pub. No.: US 2018/0137134 A1
(43) Pub. Date: May 17, 2018

(54) DATA SNAPSHOT ACQUISITION METHOD AND SYSTEM

(71) Applicant: ALIBABA GROUP HOLDING LIMITED, George Town (KY)

(72) Inventor: Xiaoyong DENG, Hangzhou (CN)

(73) Assignee: ALIBABA GROUP HOLDING LIMITED

(21) Appl. No.: 15/870,675

(22) Filed: Jan. 12, 2018

Related U.S. Application Data
(63) Continuation of application No. PCT/CN2016/088518, filed on Jul. 5, 2016.

(30) Foreign Application Priority Data
Jul. 14, 2015 (CN) 201510413154.8

(51) Int. Cl. G06F 17/30

(52) U.S. Cl. CPC G06F 17/30088; G06F 2201/84; G06F 17/30563; G06F 17/30144

(57) ABSTRACT

Embodiments of the present application provide a data snapshot acquisition method and system. The method includes: acquiring a data change record on the basis of a redo log file started from a position and recorded in a source end; loading the data change record to a destination end; and acquiring, in the destination end, a first data snapshot corresponding to a preset time according to the data change record when the preset time arrives. The present application can acquire a data snapshot of a specified time precisely.

### CROSS REFERENCE TO RELATED APPLICATION

The disclosure claims the benefits of priority to International Application No. PCT/CN2016/088518, filed Jul. 5, 2016, which is based on and claims the benefits of priority to Chinese Application No. 201510413154.8, filed Jul. 14, 2015, both of which are incorporated herein by reference in their entireties.

### BACKGROUND

With the development of information technology, more and more enterprises have established numerous information systems to help the enterprises process and manage internal and external business. However, with the increasing of information systems, the isolation of different information systems leads to a large amount of redundant data and the duplication of work for service personnel. Enterprise Application Integration (EAI) emerged at the right moment, and Extraction-Transformation-Loading (ETL) is a primary technology for integrating data.

ETL is a process of data extraction, transformation and loading. ETL is an important link for building a data warehouse and provides a process of extracting, cleaning, transforming, and then loading business system data to a data warehouse. The purpose of ETL is to integrate data of an enterprise to provide an analysis basis for making decisions by the enterprise. The date is often scattered and messy, and has no uniform standard of formatting.

Conventionally, a common data extraction method performs an offline extraction. The offline extraction can extract desired data mainly by traversing all data according to a data interface provided by a source end. Conventional source-end extraction (such as “select”) belongs to the offline extraction. Because the current status of source data is directly traversed in the offline extraction, a data snapshot may be acquired directly without any data calculation.

However, in practice the offline extraction has several deficiencies as below. First, offline extraction does not provide a specific snapshot time point. The time when the offline extraction is performed is an approximate time (or is a period after a specified time), and a snapshot at a specified time point cannot be acquired.

Second, offline extraction does not offer a precise snapshot. In a distributed scenario (e.g., a database shard), the data state time points in a snapshot are inconsistent because distributed scheduling cannot achieve simultaneous scheduling at all execution points.

Third, offline extraction is not quick enough. As the offline extraction is configured to traverse a whole set of the source end data, the input-output ratio is quite low, especially during acquisition of a data snapshot with a large base but a small increment.

Four, online production is affected because data is extracted through a source end interface in the offline extraction and both the online production and the offline extraction use this data port. Therefore, offline extraction may lead to a delayed response and even the breakdown of the online production.

Therefore, a technical problem to be urgently solved by those skilled in the art at present is: how to provide a data snapshot acquisition method and system to obtain a data snapshot of a specified time precisely.

### SUMMARY

A technical problem to be solved in the embodiments of the present application is to provide a data snapshot acquisition method to obtain a data snapshot of a specified time precisely.

Correspondingly, embodiments of the present application further provide a data snapshot acquisition system to ensure implementation and application of the foregoing method.

To solve the foregoing problem, embodiments of the present application disclose a data snapshot acquisition method, the method including: acquiring a data change record on the basis of a redo log file started from a specified position and recorded in a source end; loading the data change record to a destination end; and acquiring, in the destination end, a first data snapshot corresponding to the preset time according to the data change record, when a preset time arrives.

Preferably, the method further includes: organizing, if there is a previously-acquired second data snapshot at the position, the first data snapshot and the second data snapshot into a third data snapshot of the preset time.

Preferably, the method further includes: adding tag information to the data change record when the data change record is loaded to the destination end.

Preferably, the data change record includes a primary key identifier, and the step of acquiring, in the destination end, a first data snapshot corresponding to a preset time according to the data change record when the preset time arrives includes: detecting the tag information in the destination end, and determining whether the preset time has arrived; reversely sorting the data change records of each primary key identifier if the preset time has arrived; and acquiring a first sequential data record for each primary key identifier as a first data snapshot of the primary key identifier.

Preferably, the data change record further includes a data number, and the step of reversely sorting the data change records of each primary key identifier includes: reversely sorting the data change records of each primary key identifier according to the data numbers if the preset time has arrived.

Preferably, the step of loading the data change record to a destination end includes: publishing the data change record to a preset subscriber by using a preset publisher, wherein the subscriber is configured to subscribe to the data change record from the publisher; transforming, by the subscriber, the data change record to a data format required by the destination end; and loading, by the subscriber, the data change record in the transformed data format to a data table of the destination end.

Preferably, the data change record includes a source end change timestamp, and the step of loading, by the subscriber, the data change record in the transformed data format to a data table of the destination end includes: determining, by the subscriber, the storage partition to which the data change record belongs according to the source end change timestamp of each data change record, the storage partition including a storage partition identifier; and writing the data change record into the corresponding storage partition, and writing the identifier corresponding to the storage partition into a position corresponding to the data change record in the data table.

Preferably, the method further includes: storing data change records within a preset time period.

Preferably, the step of acquiring a data change record on the basis of a redo log file recorded in a source end further includes: collecting redo log files started from a specified position and recorded in a plurality of source ends into the publisher in a centralized way, and parsing the redo log files by using the publisher to obtain corresponding data change records.

Preferably, the first data snapshot includes a first primary key identifier, a change type, and first numerical information, the second data snapshot includes a second primary key identifier and second numerical information, and the step of organizing the first data snapshot and the second data snapshot into a third data snapshot of the preset time includes: merging the first data snapshot and the second data snapshot according to the first primary key identifier and/or the second primary key identifier; and organizing the second primary key identifier and the second numerical information into a third data snapshot if the first primary key identifier is null; or organizing the first primary key identifier and the first numerical information into a third data snapshot if the first primary key identifier is not null.

The embodiments of the present application further disclose a data snapshot acquisition system, the system including: a data record acquisition module, configured to acquire a data change record on the basis of a redo log file started from a position and recorded in a source end; a data loading module, configured to load the data change record to a destination end; and a snapshot acquisition module, configured to acquire, in the destination end, a first data snapshot corresponding to a preset time according to the data change record when the preset time arrives.

Preferably, the system further includes: a merging module configured to organize, if there is a previously-acquired second data snapshot at the preset position, the first data snapshot and the second data snapshot into a third data snapshot of the preset time.

Preferably, the system further includes: a tagging module, configured to add tag information to the data change record when the data change record is loaded to the destination end.

Preferably, the data change record includes a primary key identifier, and the snapshot acquisition module includes: a determination sub-module, configured to detect the tag information in the destination end and determine whether the preset time has arrived; a sorting sub-module, configured to reversely sort the data change records of each primary key identifier if the preset time has arrived; and a snapshot acquisition sub-module, configured to acquire a first sequential data record of each primary key identifier as a first data snapshot of the primary key identifier.

Preferably, the data change record further includes a data number, and the sorting sub-module is further configured to: reversely sort the data change records of each primary key identifier according to the data numbers if the preset time has arrived.

Preferably, the data loading module includes: a publishing sub-module, configured to publish the data change record to a preset subscriber by using a preset publisher, wherein the subscriber is configured to subscribe to the data change record from the publisher; a format transformation sub-module, configured to transform, by the subscriber, the data change record to a data format required by the destination end; and a loading sub-module, configured to load, by the subscriber, the data change record in the transformed data format to a data table of the corresponding destination end.

Preferably, the data change record includes a source end change timestamp, and the format transformation sub-module includes: a partition determination unit, configured to determine, by the subscriber, the storage partition to which the data change record belongs according to the source end change timestamp of each data change record, the storage partition including a storage partition identifier; and a writing unit, configured to write the data change record into the storage partition and write the identifier corresponding to the storage partition into a position corresponding to the data change record in the data table.

Preferably, the system further includes: a storage module, configured to store data change records within a preset time period.

Preferably, there are multiple source ends, and the data record acquisition module includes: a collection sub-module, configured to collect redo log files started from a specified position and recorded in multiple source ends into the publisher in a centralized way, and parse the redo log files by using the publisher to obtain corresponding data change records.

Preferably, the first data snapshot includes a first primary key identifier, a change type, and first numerical information, the second data snapshot includes a second primary key identifier and second numerical information, and the merging module includes: a merging sub-module, configured to merge the first data snapshot and the second data snapshot according to the first primary key identifier and/or the second primary key identifier; a first organization sub-module, configured to organize the second primary key identifier and the second numerical information into a third data snapshot if the first primary key identifier is null; and a second organization sub-module, configured to organize the first primary key identifier and the first numerical information into a third data snapshot if the first primary key identifier is not null.

Embodiments of the present application include the following advantages:

a. Any snapshot time point can be specified: by using the change flow obtained from a redo log file, the embodiments of the present application can reversely sort data having the same key according to time, and by calculation, a data snapshot at any time point can be obtained.

b. Precise snapshot: even in a distributed situation (ignoring clock differences between distributed hosts), data snapshots with consistent time points can be obtained as long as time points of changed data are acquired from a redo log.

c. Rapid acquisition: embodiments of the present application obtain a data change record from a redo log file without traversing the whole data set, and thus the ETL speed is very fast.

d. Isolated production: embodiments of the present application read the redo log file instead of using a source end data access interface, and thus have slight influence or even no influence on online production.

e. Universality: embodiments of the present application are universal for any storage system with a redo log file, and all the above technical effects can be achieved as long as a change flow can be acquired from a redo log.

### BRIEF DESCRIPTION OF THE DRAWINGS

FIG. 1 is a flowchart of a data snapshot acquisition method, according to embodiments of the present disclosure.

FIG. 2A is a schematic diagram of codes for incremental merging of a data snapshot acquisition method, according to embodiments of the present disclosure.

FIG. 2B illustrates a table of exemplary data change records loaded to the destination end, according to embodiments of the present disclosure.

FIG. 2C illustrates a table of exemplary results obtained by reversely sorting, according to embodiments of the present disclosure.

FIG. 3 is a flowchart of another data snapshot acquisition method, according to embodiments of the present disclosure.

FIG. 4 is a schematic diagram of codes for global merging of a data snapshot acquisition method, according to embodiments of the present disclosure.

FIG. 5 is a structural diagram of a data snapshot acquisition system, according to embodiments of the present disclosure.

### DETAILED DESCRIPTION

In order to make the foregoing objectives, features, and advantages of the present application more comprehensible, the present application is described in further detail in the following with reference to the accompanying drawings and specific embodiments.

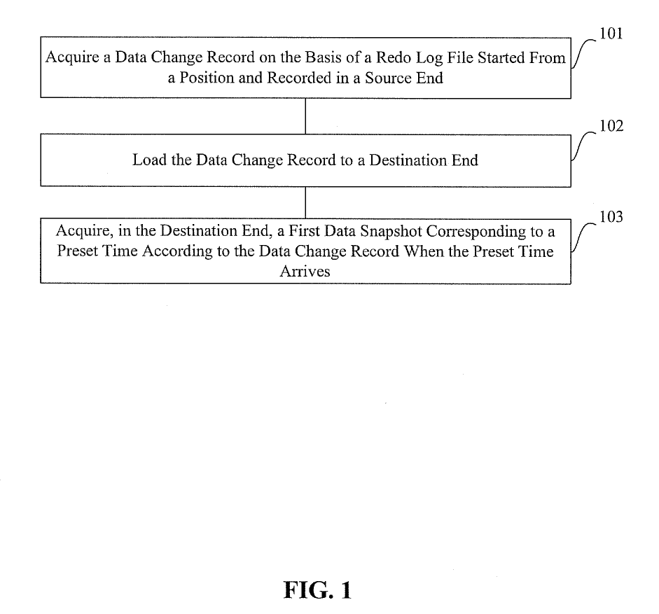

FIG. 1 is a flowchart of a data snapshot acquisition method, according to embodiments of the present disclosure. The method can include steps 101-103.

In step 101, based on a redo log file started from a specified position and recorded in a source end, a data change record is acquired.

The embodiment of the present disclosure may be applied to an ETL system. During a data extraction stage, the present disclosure may obtain a data change record on the basis of a redo log file recorded in a source end.

In some embodiments, structured data (e.g., row data) can be stored in a source end storage system (e.g., MySQL, Oracle, Hbase and the like). The structured data can be used to express data by a two-dimensional table logic structure in a storage system. The data generally has a redo log file in the storage system. A change of the data of the structured storage can be recorded in a log in the form of a redo log file. For example, when a database system executes an update operation, it may cause a change in a database, and thus a certain number of redo logs may be generated. The redo logs are recorded into a redo log file, so that when a routine failure or media fault occurs in the database, the database may be restored using the redo log file. In some embodiments, the source end data change flow can be acquired using a redo log file.

The embodiment of the present disclosure may be applied to a distributed environment, and there may be multiple source ends. In some embodiments, step 101 may further include a sub-step S11.

In sub-step S11, redo log files started from a specified position and recorded in multiple source ends are collected into a preset publisher in a centralized manner, and the redo log file is parsed using the publisher to obtain corresponding data change records.

It is not necessary to parse data in the source ends where the redo log files are located, thereby providing good isolation from the source ends and reducing consumption of source end resources.

In some embodiments, during the centralized collection, different collection manners may be employed for different source ends. For example, for MySQL, collection may be performed by master-slave replicating a binary log. For a source end having no existing redo log replication scheme, collection may be directly implemented by means of file copying or the like. The file copying can be, for example, rsync (a data mirroring backup tool in a Unix-like system).

To avoid repeated collection of the redo log file, after previous collection of the redo log file is completed, the position where the collection stops may be marked. The marked position or the position of the unit data after the marked position may serve as a specified position, and next collection starts from the specified position. In some embodiments, marking may be based on a time parameter. For example, a previous collection stops at a redo log file for 8 o'clock on Apr. 20, 2015, so a mark is made at 8 o'clock on Apr. 20, 2015, and the specified position may be 8 o'clock on Apr. 20, 2015. Alternatively, a marking may also be based on a file number parameter. For example, a previous collection stops at the redo log file numbered 4, a mark is made at the number “4”, and the specified position may be the position after the position numbered “4”. For example, the specified position can be a position numbered “5”. The specified position may also be determined in another manner, which is not limited in the embodiments of the present application.

After the redo log files are collected, the publisher further parses the redo log files into data of a recognizable data format and obtains corresponding data change records. In some embodiments, changes in a database may be continuously added to a redo log file. That is, the redo log records a data change flow. After the redo log is parsed, a corresponding change flow record can be obtained.

The recognizable format may be a row-column format of Excel™ (one row represents one record, and different columns have different meanings), a Json format (one Json represents one record, and different internal keys have different meanings), or a program object that includes records, or it may be protobuf, avro, and other serialized formats.

In embodiments of the application, for redo log files of different source ends, the redo log files can be parsed in different manners, such as Oracle's logminer, MySQL's mysqlbinlog, and the like.

In embodiments of the present application, the data change records obtained after parsing are not exactly the same as the data recorded in the redo log file of the source end. The data in the source end only indicate specific data fields, and the record may include two parts: meta information and numerical information. The meta information may include a primary key identifier, a change type (e.g., INSERT, UPDATE, DELETE, and like), a source end library name, a source end table name, a source end change timestamp, and so on. For a change of DELETE, at least a primary key identifier of the change should be given. The numerical information may be recorded in a List<Field>. Each “Field” object also has its own meta information. For example, the meta information can include a data type (INT, FLOAT, DOUBLE, STRING, DATE, BLOB, and the like), a field name, a field code, a specific field value, and so on.

It should be noted that, embodiments of the present application are not limited to the above centralized collection manner. It is appreciated that the redo log files can be processed separately according to a database shard position. That is, the redo log file is parsed locally at the source end. This achieves the advantage of saving online transmission of the redo log file (it is not necessary to transmit the redo log file to a publisher), but this manner may consume various resources (e.g., CPU, memory, network and other resources) of different source ends, thus affecting online services.

In embodiments of the present application, after the data change records are obtained, data change records can be stored within a preset time period. For example, during the operation of the system of this embodiment, an abnormal situation, such as a user logic error, loss of data, or system outage, may occur, while a real-time data stream moves forward constantly. So after the abnormal situation occurs, it is necessary to return the whole stream location point to a safe time point (preset time period) after recovery from the abnormal situation, and extract stream data again. The extraction of the steam data can be considered as a process of supplementing data. If the stream data (e.g., the data change records) within the preset time period is cached after parsing, the data change records may be extracted directly from this cached stream data. A time location point that can be returned should be made within the cache time range. Therefore, it is not necessary to re-extract the redo log file from the source end and then parse the redo log file.

It should be noted that, embodiments of the present application parse the redo log file, therefore parsed data change records having an identical primary key are arranged according to the actual change order. That is, the order of data having the same key is preserved. For data having different keys or database shard data, the time difference between them (between two keys, between two tables, or between two databases) should not be too great. Thus, for some scenarios where data transaction is demanded, no requirement is needed. A data transaction scenario may indicate that a batch of data operations can be either all succeed or all fail. For example, a bank wants to add 100 Yuan to a batch of accounts (e.g., ten accounts). In this case, the data transaction scenario is: this operation ensures that all the ten accounts are increased by 100 Yuan. Otherwise, none of the ten accounts is increased. It is not allowed that some are increased while some are not increased. Otherwise, it is difficult to find out which accounts are increased successfully and which accounts are not, causing inconvenience to subsequent operations.

Embodiments of the present application can acquire data change records by extracting a redo log file at the data extraction stage, and can achieve sorting according to time of data having the same key. It is not necessary to traverse a whole data set, thereby increasing ETL speed greatly. Moreover, a data snapshot of any specified time (“any specified time” will be described hereinafter) can be acquired.

In step 102, the data change record can be loaded to a corresponding destination end.

Because embodiments of the present application can be applied to a distributed environment, there may be multiple destination ends. After a data change record is acquired, the data change record may be loaded to a corresponding destination end.

In a preferred implementation of the embodiment of the present application, step 102 may include the following sub-steps S21-S23.

In sub-step S21, the data change record can be published to a preset subscriber, by using a preset publisher, wherein the subscriber is a program that subscribes to the data change record from the publisher.

To realize light coupling between systems, embodiments of the present application is further provided with a subscriber in addition to the publisher. The publisher is dedicated to parsing and publishing the redo log file, but does not focus on the flow direction and use of published data. The subscriber can be configured to subscribe to the data published by the publisher and load the data to the destination end. According to embodiments of the present application, parsing and loading operations can be completed through two different programs, achieving light coupling between systems. Because the amount of data in a distributed environment is too large, the data change records published by the publisher can be processed by multiple subscribers, in view of the subscriber performance. For example, 10 subscribers can subscribe to and consume the same batch of data, and each subscriber may be responsible for 1/10 of the amount of data.

For example, if no change operation has actually occurred at a source end in a long time, it is difficult for a subscriber to determine whether new data has arrived or whether there are problems in the parsing and publishing process. Therefore, the publisher may constantly send out heartbeats (e.g., once per second) to the subscriber to ensure the forward movement of data time.

In sub-step S22, the data change record can be transformed to a data format required by the destination end by using the subscriber.

After obtaining the data change record, the subscriber may transform the data change record to a data format required by the destination end. The data in this format, as a link for calculation, is acquired from a source end and written into a destination end. For example, the transformation may include format conversion of meta information and format conversion of numerical information.

In some embodiments, the data change record may be transformed to a format form in Table 1 below:

TABLE 1

| | | | | | | | |
|---|---|---|---|---|---|---|---|
| Multi-bit | Source | Source | Source | Change | Field0 | Field1 | . . . |
| Cyclic | End | end | End | Type | Value | Value | |
| Synchronous | Change | Library | Table | | | | |
| Sequence | Timestamp | Name | Name | | | | |
| Number | | | | | | | |

In Table 1 above: the multi-bit cyclic synchronous sequence number can indicate the data number of the data change record. Data lengths of this field are equal in length, synchronous sequence numbers are cyclically assigned. The number of bits of the synchronous sequence number depends on the granularity of the source end change timestamp and the maximum number of changes in a single source end table within this granularity. For example, if the granularity of the source end change timestamp is one second and the maximum number of changes in a table within one second is 50,000 times (that is, the table changes 50,000 times at most), the synchronous sequence number may have 5 digits or more (for example, 00001). In other words, 5 or more digits can indicate the changes within the next one second. Because the timestamp of the source end change for the next one second is different from the data of the previous one second, the multi-bit synchronous sequence number can be recycled. This field is a sorting field for data having the same key at the destination end.

The timestamp of the source end change indicates the actual time of a source end data change. The timestamp of the source end change can be used to determine the storage range of the destination end where the data change record is going to be written. The reason why the above multi-bit cyclic synchronous sequence number rather than this field is employed as the sorting field is that, the parsed change time may have a relatively large granularity. For example, if the change time can be measured by microseconds, source end data having the same key may also have too many changes within one microsecond that the sequence thereof cannot be distinguished.

The source end library name and source end table name can indicate the actual source of source end data, to facilitate data analysis and problem positioning.

The change type mainly includes INSERT, UPDATE, and DELETE parsed as described above.

The field value can indicate specific numerical information obtained through parsing. Code conversion or type conversion may be conducted herein, but high fidelity or non-distortion of the value should be ensured.

For example, when being written into Table 1 above, the data change record may be written in a row-column manner. A format of an entire row having a built-in row/column spacer may be employed. The row/column spacer is provided with a special character, and row/column replacement is performed when a row/column spacer appears in data. Json, Protobuffer, and other serialized formats may be employed. But basic meta information is described as in Table 1 above.

In sub-step S23, the data change record in the transformed data format can be loaded to a data table of the corresponding destination end by using the subscriber.

After the subscriber transforms the data format of the data change record, the data change record in the transformed format may be loaded to a data table of the corresponding destination end.

In some embodiments of the present application, sub-step S23 may further include the following sub-steps S231 and S232.

In sub-step S231, the storage partition to which each data change record belongs can be determined using the subscriber according to the change time stamp of source end of the data change record.

The amount of data to be processed is huge in a distributed environment. To reduce destination end storage pressure and data processing pressure, multiple storage partitions can be generated for data storage, and each storage partition can store data within a certain time range. For example, if each storage partition can store data of one hour, 24 storage partitions may be allocated to the 24 hours in a day. The first storage partition can store data for 00:00-01:00, the second storage partition can store data for 01:01-02:00, the third storage partition can store data for 02:01-03:00, and so on.

After data of a time period stored in each storage partition is determined, it is possible to determine the storage partition to which the data change record belongs according to the source end change timestamp of each data change record. For example, if the source end change timestamp of a current data change record is 01:30, the data change record belongs to the second storage partition.

In sub-step S232, the data change record can be written into the corresponding storage partition, and the identifier corresponding to the storage partition can be written into a position corresponding to the data change record in the data table.

After determining the storage partition to which the data change record belongs, the subscriber can write the data change record into the storage partition. For example, the data change record having a source end change timestamp of 01:30 can be written into the second storage partition, and the identifier of the second storage partition can be written into the data table of the destination end. The identifier of the storage partition may be identified with a data number (e.g., numbers “1”, “2”, and so on), and may also be identified with a time range (e.g., a range timestamp) corresponding to the storage partition. As shown in Table 2 below, the range timestamp may be represented with “2014042009” (the identifier of the storage partition storing data in 9:00-10:00 on Apr. 20, 2014), or the like.

TABLE 2

| | | | | | | | | |
|---|---|---|---|---|---|---|---|---|
| Multi-bit | Source End | Source | Source | Change | Field0 | Field1 | . . . | Range Time |
| Cyclic | Change | End | End | Type | Value | Value | | Stamp |
| Synchronous | Time Stamp | Library | Table | | | | | |
| Sequence | | Name | Name | | | | | |
| Number | | | | | | | | |

In embodiments of the present application, the identifier of the storage partition in the data table can be used to determine the location of the data.

It should be noted that, the identifier of the storage partition can be expressed via a separate label range field for SQL-type storage (i.e., the range time stamp as shown in Table 2). For NoSQL-type storage, it can be expressed via a partition. For example, it can be expressed via a separate column or the like. But the field of the separate column in NoSQL is meta information, rather than a specific value.

To ensure integrity of data, the data loading process may further include the following step: adding tag information to the data change record when the data change record is loaded to the destination end.

In some embodiments, during the process of writing the data change record into the destination end, tag information may be added for the data change record according to service requirements and the time. The data change record can be dotted to add the tag information. For example, one dot is made each time when data of one hour is written, or a dot is made when a specified time arrives, or a dot is made according to the time of a storage partition. Therefore, the destination end may determine, according to the dotting situation, whether the data is complete and whether the specified time has arrived.

It should be noted that, for data having different keys, processing from the publisher to the subscriber can be completed within a time range (e.g., 5 minutes), to ensure that time differences between processing of the data having different keys are within a reasonable range. Therefore, data loss due to subsequent calculation time delays or incomplete data can be avoided. For example, a piece of data is processed at 0:00 in the morning, but there is still data at 20:00 in the evening. If the time range is not limited, a current change situation cannot be globally acquired at 0:00 in the morning.

In step 103, in the destination end, when a preset specified time arrives, a first data snapshot corresponding to the specified time can be acquired according to the data change record.

After the data change record is loaded to the destination end, a first data snapshot corresponding to a time specified by a user (e.g., a developer, a data analyst, and the like) can be acquired in the destination end. The data snapshot can include a data copy of data in the storage system of the source end for a certain moment in another storage system or a storage system at another place (i.e., the destination end).

In embodiments of the present application, step 103 may include the following sub-steps S31-S33.

In sub-step S31, the tag information can be detected in the destination end, and can be determined whether the specified time has arrived.

Dotting can be performed according to a specified time. When a dot is detected, it indicates that the specified time has arrived and the data change record at the dot is completely loaded.

Dotting can be performed according to a time interval. When a dot is detected, it can indicate that a specified time corresponding to the dot has arrived and the data change record corresponding to the dot is loaded. For example, one dot is made every hour and the specified time is 04:00. Therefore, when the fourth dot since 00:00 is read, it indicates that the specified time has arrived and the data change record at the fourth dot is completely loaded.

In sub-step S32, data change records of each primary key identifier can be reversely sorted if the specified time has arrived.

In sub-step S33, the first sequential data record of each primary key identifier can be acquired as a first data snapshot of the primary key identifier.

In some embodiments, a sorting field of data having the same key at the destination end can be a multi-bit cyclic synchronous sequence number. When the specified time arrives, data change records of each primary key identifier may be sorted according to the multi-bit cyclic synchronous sequence number (e.g., data number). To save data traversal time and improve data search efficiency, the sorting manner can be reversely sorting. Therefore, the first sequential data record is the data record of the primary key identifier in the final state. In embodiments of the present application, the process of sub-step S32 and sub-step S33 is a process of incremental merging. In this case, the first data snapshot is an incremental snapshot obtained after the data change records are incrementally merged. In incremental merging, a start point T0 (e.g., the specified position) of a change flow can be specified, and data having the same key can be connected according to the sequence of changes (e.g., data having the same key is reversely sorted), to acquire a final state of all data at a cut-off time point T1 (e.g., the specified time), and the data in the final state is called an incremental snapshot.

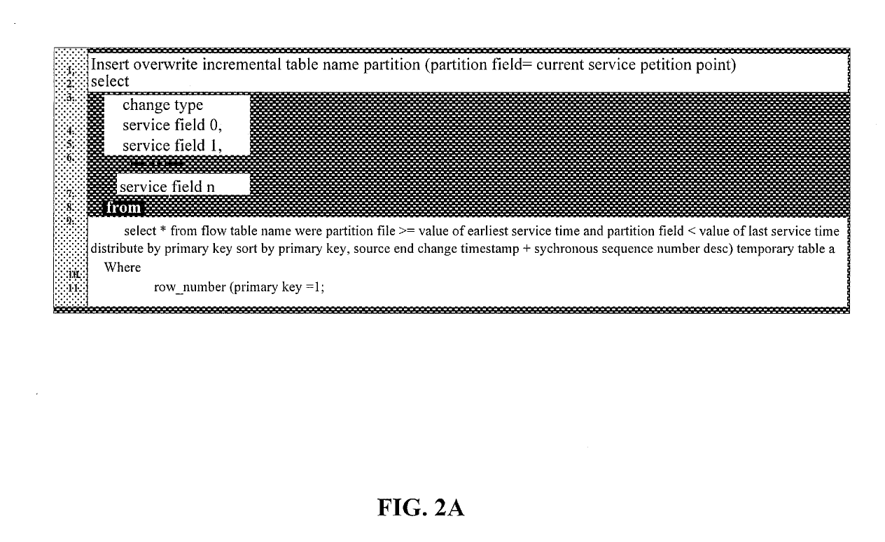

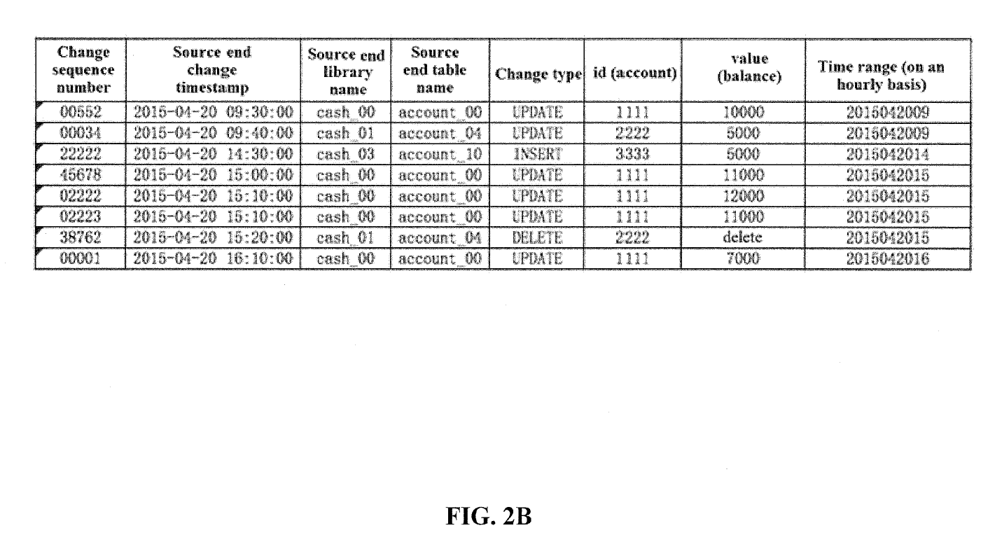

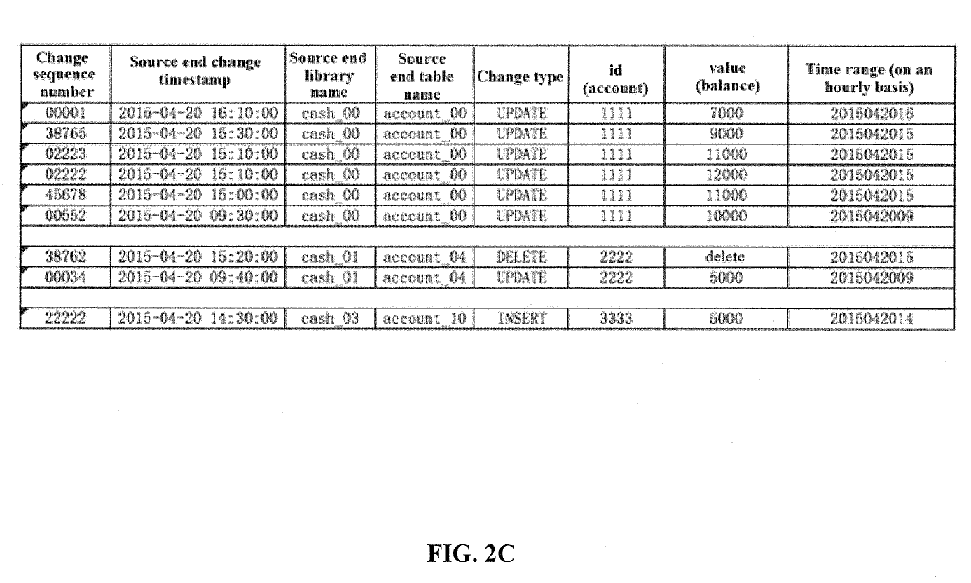

In some embodiments of the application, pseudo SQL codes in the process of acquiring the first data snapshot are as shown in the incremental merge code schematic diagram in FIG. 2A. The meaning of the ninth row is that after all data within a data range (partition field) is selected and data having the same primary key is gathered together, reversely sorting is performed according to the primary keys, source end change timestamps, and synchronous sequence numbers (i.e., multi-bit cyclic synchronous sequence numbers) to obtain a temporary table A. The where condition in the eleventh row indicates selecting first changed data and finally inserting the first changed data in the corresponding data range of the increment table, to obtain a first data snapshot of all the primary key identifiers at the latest moment within the specified time.

An exemplary process of acquiring the first data snapshot is illustrated in the following by using the form of a temporary table as shown in FIGS. 2B and 2C, respectively. However, it should be noted that FIGS. 2B and 2C are temporary tables, which may not be stored in actual implementation. This example is merely a process analysis example. The pseudo SQL code in FIG. 2A is the first data snapshot finally generated after the logic is processed directly:

In the first step: a redo log file for a time range from a specified position to a specified time is selected according to service requirements. In the example, the selected specified position is 2015-04-20 00:00:00 and the specified time is 2015-04-21 00:00:00, that is, a redo log file for the time range of [2015-04-20 00:00:00, 2015-04-21 00:00:00] is selected, and after the redo log file is parsed, the data change records loaded to the destination end are as shown in FIG. 2B.

In the second step: the data change records in FIG. 2B above are grouped according to primary key identifiers. For each group of data having the same key, reversely sorting is performed according to change sequence numbers (e.g., multi-bit cyclic synchronous sequence numbers) to obtain results as shown in FIG. 2C.

In the third step: the first sequential data record of each primary key identifier is obtained, and a final state before the moment 2015-04-21 00:00:00 can be obtained. The final state can be a first data snapshot for 2015-04-21 00:00:00, as shown in Table 3 below:

TABLE 3

| | | | Time Range (on |
|---|---|---|---|
| Change type | ID (account) | Value (balance) | an hourly basis) |
| UPDATE | 1111 | 7000 | 2015042016 |
| DELETE | 2222 | delete | 2015042015 |
| INSERT | 3333 | 5000 | 2015042014 |

It should be noted that, the time range illustrated above is merely one day. That is, only a data snapshot of one day is taken. However, the time range may be of a finer granularity. For example, a hour-based precise snapshot, or even a minute-level precise snapshot can be obtained.

Using embodiments of the present application, the following beneficial effects can be achieved:

a. Any snapshot time point can be specified: by using the change flow obtained from a redo log file, the embodiment of the present application can reversely sort data having the same key according to time, and by calculation, a data snapshot at any time point can be obtained.

b. Precise snapshot: even in a distributed situation (ignoring clock differences between distributed hosts), data snapshots with consistent time points can be obtained as long as time points of changed data are acquired from a redo log.

c. Rapid acquisition: the embodiment of the present application obtains a data change record from a redo log file without traversing the whole data set, and thus the ETL speed is very fast.

d. Isolated production: the embodiment of the present application reads the redo log file instead of using a source end data access interface, and thus has slight influence or even no influence on online production.

e. Universality: the embodiment of the present application is universal for any storage system with a redo log file, and all the above technical effects can be achieved as long as a change flow can be acquired from a redo log.

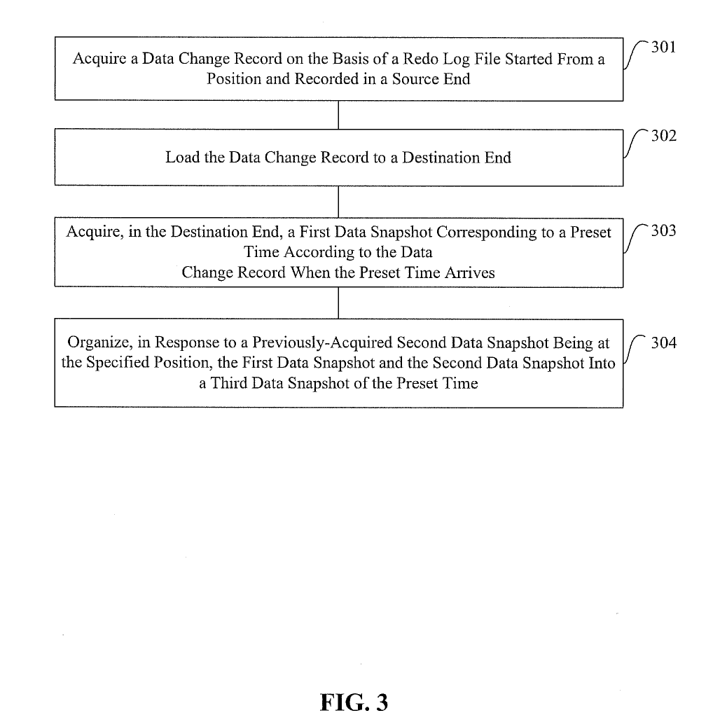

Referring to FIG. 3, a flowchart of the steps of a second embodiment of a data snapshot acquisition method according to the present application is shown, which may include the following steps 301-304.

In step 301, a corresponding data change record can be acquired based on a redo log file started from a specified position and recorded in a source end.

In embodiments of the present application, step 301 may include the following sub-step S41.

In sub-step S41, redo log files started from a specified position and recorded in multiple source ends can be collected into a preset publisher in a centralized way, and the redo log files are parsed by using the publisher to obtain corresponding data change records.

In embodiments of the present application, the data change record obtained after parsing is not exactly the same as data recorded in the redo log file of the source end. The data in the source end is only specific data fields. And the record may include two parts: meta information and numerical information. The meta information may include a primary key identifier, a change type, a source end library name, a source end table name, a source end change timestamp, and so on. The numerical information may be recorded in a List<Field>, and each Field object also has its own meta information, for example, a data type (INT, FLOAT, DOUBLE, STRING, DATE, BLOB, and the like), a Field name, a Field code, a specific Field value, and so on.

In embodiments of the present application, after the data change records are obtained, data change records can be stored within a preset time period. During the operation of the system of this embodiment, an abnormal situation (such as a user logic error, loss of data, or system outage) may occur, while a real-time data stream moves forward constantly. So after the abnormal situation occurs, the whole stream location point is returned back to a safe time point (preset time period) after recovery from the abnormal situation, and extract stream data again. The extraction of the steam data may be considered as a data supplementing process. If stream data (e.g., data change records) within the preset time period is cached after parsing, the data change records may be extracted directly from this cached stream data. A time location point that can be returned should be made within the cache time range. Therefore, it is not necessary to re-extract the redo log file from the source end and then parse the redo log file.

In step 302, the data change record can be loaded to a corresponding destination end.

In some embodiments, in a distributed environment, there may be multiple destination ends. After a data change record is acquired, the data change record may be loaded to a corresponding destination end.

In some embodiments of the present application, step 302 may include the following sub-steps S51-S53.

In sub-step S51, the data change record can be published to a preset subscriber by using a preset publisher, wherein the subscriber is a program that subscribes to the data change record from the publisher.

In sub-step S52, the data change record can be transformed to a data format required by the destination end by using the subscriber.

In sub-step S53, the data change record in the transformed data format can be loaded to a data table of the corresponding destination end by using the subscriber.

In embodiments of the present application, sub-step S53 may further include the following sub-steps S531 and S532.

In sub-step S531, the storage partition to which each data change record belongs can be determined by using the subscriber according to the change time stamp of source end of the data change record.

In sub-step S532, the data change record can be written into the corresponding storage partition, and the identifier corresponding to the storage partition is written into a position corresponding to the data change record in the data table.

To ensure integrity of data, the data loading process may further include the following step: adding tag information to the data change record when the data change record is loaded to the destination end.

In step 303, in the destination end, when a preset specified time arrives, a first data snapshot corresponding to the specified time can be acquired according to the data change record.

In embodiments of the present application, step 303 may include the following sub-steps S61-S63.

In sub-step S61, the tag information can be detected in the destination end, and can be determined whether the specified time has arrived.

In sub-step S62, data change records of each primary key identifier can be reversely sorted if the specified time has arrived.

In embodiments of the present application, sub-step S62 may be: reversely sorting the data change records of each primary key identifier according to data numbers if the specified time has arrived.

In sub-step S63, the first sequential data record of each primary key identifier can be acquired as a first data snapshot of the primary key identifier.

In step 304, if there is a previously-acquired corresponding second data snapshot at the specified position, the first data snapshot and the second data snapshot are organized into a third data snapshot of the specified time.

In embodiments of the present application, the first data snapshot includes a first primary key identifier, a change type, and first numerical information, the second data snapshot includes a second primary key identifier and second numerical information, and step 304 may include the following sub-steps S71-S73.

In sub-step S71, if there is a previously-acquired corresponding second data snapshot at the specified position, the first data snapshot and the second data snapshot can be merged according to the first primary key identifier and/or the second primary key identifier.

In embodiments of the present application, the second data snapshot is a total snapshot of the specified position. A total snapshot is a result of merging all data of a specified position, and total merging means incrementally merging data within a time range from T0 to T1 and then merging the data to a total snapshot at the moment of T0 to obtain a total snapshot at the moment of T1. By repeatedly using this method, a total snapshot at each time point can be obtained sequentially. Therefore, if the specified position is an initial position, there is no second data snapshot at the specified position. Otherwise, if the specified position is not an initial position, there is a second data snapshot at the specified position.

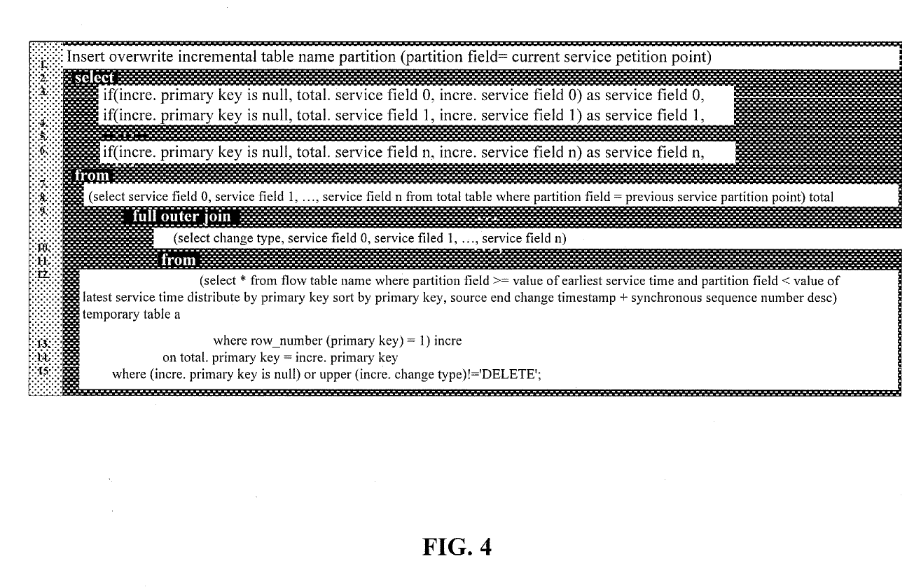

Referring to the schematic diagram of the total merge code shown in FIG. 4, the 10^{th} to 13^{th} rows indicate performing incremental merging to obtain a temporary increment table “incre”. That is, an incremental snapshot of a specified time is obtained. The 8^{th} row indicates acquiring a total value table total of the previous service point. That is, a second data snapshot for a specified position can be obtained. A “full outer join” is performed on the incremental snapshot of the specified time and the second data snapshot of the specified position, and the join condition is that the primary keys thereof are equal (the 14^{th} row). Therefore, a total increment wide table can be obtained. In the total increment wide table, the columns are headed with “total” and “incre” respectively, wherein the “incre” values are all null for unchanged data.

In sub-step S72, the second primary key identifier and the second numerical information can be organized into a third data snapshot if the first primary key identifier is null.

In sub-step S73, the first primary key identifier and the first numerical information can be organized into a third data snapshot if the first primary key identifier is not null.

After data filtering, whether total numerical information or incremental numerical information is selected for a single piece of data is determined by the if condition in the third to sixth rows in FIG. 4. If there is no incremental numerical information, a total numerical information field value is selected. Otherwise, an incremental numerical information field value is selected to obtain a total snapshot of all data at the latest moment of the specified time.

It should be noted that acquisition of the third data snapshot and acquisition of the first data snapshot can be implemented by the same computing program, that is, they can be implemented directly in one step. Merging of the increment and total is completed by using one computing program, but an incremental snapshot may not be stored, and this manner is shown by the pseudo-code in FIG. 4. Acquisition of the third data snapshot and acquisition of the first data snapshot may also be implemented by two different computing programs. That is, after the first data snapshot is obtained, another computing program is started to calculate the third data snapshot.

To make those skilled in the art better understand the embodiment of the present application, the process of acquiring the third data snapshot is illustrated in the following by using the form of a temporary table. However, it should be noted that Table 6 and Table 7 below are temporary tables, which may not be stored in actual implementation. This example is merely a process analysis example. The pseudo SQL code in FIG. 4 is the third data snapshot finally generated after the logic is processed directly:

In the first step: an incremental final state table (i.e., the first data snapshot) for a service time point (2015-04-20) is obtained according to incremental merging, as shown in Table 4.

TABLE 4

| | | | Time Range (on an |
|---|---|---|---|
| Change type | ID (account) | Value (balance) | hourly basis) |
| UPDATE | 1111 | 7000 | 2015042016 |
| DELETE | 2222 | delete | 2015042015 |
| INSERT | 3333 | 5000 | 2015042014 |

In the second step: a total table of the day before, i.e., specified position (2015-04-19), is obtained, as shown in Table 5:

TABLE 5

| ID (account) | Value (balance) | Time Range |
|---|---|---|
| 1111 | 5000 | 20150419 |
| 2222 | 3000 | 20150419 |
| 4444 | 6000 | 20150419 |

In the third step: full outer join is performed on Table 4 and Table 5, and the join condition is joining according to keys (primary keys), as shown in Table 6.

TABLE 6

| Incremental | | Incremental | | |
|---|---|---|---|---|
| Change | Increment ID | Value | Total ID | Total Value |
| Type | (account) | (balance) | (account) | (balance) |
| UPDATE | 1111 | 7000 | 1111 | 5000 |
| DELETE | 2222 | delete | 2222 | 3000 |
| INSERT | 3333 | 5000 | | |
| | | | 4444 | 6000 |

In the fourth step: data filtering is performed by retaining data whose incremental primary key is null or incremental change type is not DELETE, as shown in Table 7.

TABLE 7

| Incremental | Increment id | Increment value | Total ID | Total value |
|---|---|---|---|---|
| change type | (account) | (balance) | (account) | (balance) |
| UPDATE | 1111 | 7000 | 1111 | 5000 |
| INSERT | 3333 | 5000 | | |
| | | | 4444 | 6000 |

In the fifth step: a value is assigned; when the incremental primary key is null, total values are assigned to all the fields; otherwise, incremental values are assigned to all the fields, thus obtaining a final total snapshot of 2015-04-20, as shown in Table 8.

TABLE 8

| ID (account) | Value (balance) |
|---|---|
| 1111 | 7000 |
| 3333 | 5000 |
| 4444 | 6000 |

It should be noted that, the time range illustrated above is merely one day. That is, only a data snapshot of one day is taken. In fact, the time range may be of a finer granularity, for example, a hour-based precise snapshot.

As shown in FIG. 3, because it is similar to the method embodiment of FIG. 1, the description is relatively simple. Reference can be made to the description of the part of the method embodiment for related contents.

It should be noted that for ease of description, the foregoing method embodiments are described as a series of action combinations. However, those skilled in the art should understand that the present application is not limited to the described sequence of the actions, because some steps may be performed in another sequence or at the same time according to the embodiments of the present application. In addition, those skilled in the art should also understand that the embodiments described in this specification all belong to preferred embodiments, and the involved actions and modules are not necessarily mandatory to the present application.

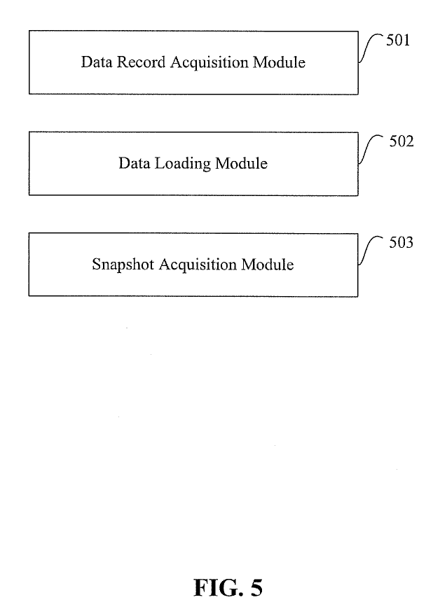

Referring to FIG. 5, a structural block diagram of an embodiment of a data snapshot acquisition system according to embodiments of the present application is shown, which may specifically include the following modules 501-503.

A data record acquisition module 501 can be configured to acquire a corresponding data change record on the basis of a redo log file started from a specified position and recorded in a source end.

A data loading module 502 can be configured to load the data change record to a corresponding destination end.

A snapshot acquisition module 503 can be configured to acquire in the destination end, when a preset specified time arrives, a first data snapshot corresponding to the specified time according to the data change record.

In embodiments of the present application, the system may further include:

a merging module configured to organize, if there is a previously-acquired corresponding second data snapshot at the specified position, the first data snapshot and the second data snapshot into a third data snapshot of the specified time.

In embodiments of the present application, the system may further include:

a tagging module configured to add tag information for the data change record as required when the data change record is loaded to the destination end.

In embodiments of the present application, the data change record includes a primary key identifier, and snapshot acquisition module 503 may include the following sub-modules:

a determination sub-module configured to detect the tag information in the destination end and determine whether the specified time has arrived;

a sorting sub-module configured to reversely sort the data change records of each primary key identifier when the specified time arrives; and

a snapshot acquisition sub-module configured to acquire the first sequential data record of each primary key identifier as a first data snapshot of the primary key identifier.

In embodiments of the present application, the data change record further includes a data number, and the sorting sub-module may be further configured to:

reversely sort the data change records of each primary key identifier according to the data numbers if the specified time has arrived.

In embodiments of the present application, data loading module 502 may include the following sub-modules:

a publishing sub-module configured to publish the data change record to a preset subscriber by using a preset publisher, wherein the subscriber is a program that subscribes to the data change record from the publisher;

a format transformation sub-module configured to transform, by using the subscriber, the data change record to a data format required by the destination end; and

a loading sub-module configured to load, by using the subscriber, the data change record in the transformed data format to a data table of the corresponding destination end.

In embodiments of the present application, the data change record includes a source end change timestamp, and the format transformation sub-module may include the following units:

a partition determination unit configured to determine, by using the subscriber and according to the source end change timestamp of each data change record, the storage partition to which the data change record belongs, the storage partition including a storage partition identifier; and

a writing unit configured to write the data change record into the corresponding storage partition and write the identifier corresponding to the storage partition into a position corresponding to the data change record in the data table.

In embodiments of the present application, the system may further include:

a storage module configured to store data change records within a preset time period.

In embodiments of the present application, there are multiple source ends, and data record acquisition module 501 may include the following sub-module:

a collection sub-module configured to collect redo log files started from a specified position and recorded in multiple source ends into the publisher in a centralized way, and parse the redo log files by using the publisher to obtain corresponding data change records.

In embodiments of the present application, the first data snapshot includes a first primary key identifier, a change type, and first numerical information, the second data snapshot includes a second primary key identifier and second numerical information, and the merging module may include the following sub-modules:

a merging sub-module configured to merge the first data snapshot and the second data snapshot according to the first primary key identifier and/or the second primary key identifier;

a first organization sub-module configured to organize the second primary key identifier and the second numerical information into a third data snapshot if the first primary key identifier is null; and

a second organization sub-module configured to organize the first primary key identifier and the first numerical information into a third data snapshot if the first primary key identifier is not null.

The system embodiment is similar to the foregoing method embodiment, so it is described simply. For related parts, refer to the description of the parts in the method embodiment.

The embodiments in this specification are all described in a progressive manner, each embodiment emphasizes a difference from other embodiments, and identical or similar parts in the embodiments may be obtained with reference to each other.

Those skilled in the art should understand that the embodiments of the present application may be provided as a method, an apparatus, or a computer program product. Therefore, the embodiments of the present application may be implemented as a complete hardware embodiment, a complete software embodiment, or an embodiment combining software and hardware. Moreover, the embodiments of the present application may be in the form of a computer program product implemented on one or more computer usable storage media (including, but not limited to, magnetic disk memory, CD-ROM, optical memory, and the like) including computer usable program code.

The embodiments of the present application are described with reference to flowcharts and/or block diagrams according to the method, terminal device (system) and computer program product of the embodiments of the present application. It should be understood that a computer program instruction may be used to implement each process and/or block in the flowcharts and/or block diagrams and combinations of processes and/or blocks in the flowcharts and/or block diagrams. The computer program instructions may be provided to a general purpose computer, a special purpose computer, an embedded processor or a processor of another programmable data processing terminal device to generate a machine, such that the computer or the processor of another programmable data processing terminal device executes an instruction to generate an apparatus configured to implement functions designated in one or more processes in a flowchart and/or one or more blocks in a block diagram.

The computer program instructions may also be stored in computer readable storage that can guide the computer or another programmable data processing terminal device to work in a specific manner, such that the instructions stored in the computer readable storage generate an article of manufacture including an instruction apparatus, and the instruction apparatus implements functions designated by one or more processes in a flowchart and/or one or more blocks in a block diagram.

The computer program instructions may also be installed in a computer or another programmable data processing terminal device, such that a series of operation steps are executed on the computer or another programmable terminal device to generate computer implemented processing, and therefore, the instructions executed in the computer or another programmable terminal device provide steps for implementing functions designated in one or more processes in a flowchart and/or one or more blocks in a block diagram.

Embodiments of the present invention have been described. However, once the basic creative concepts are grasped, those skilled in the art can make other variations and modifications to the embodiments. Therefore, the appended claims are intended to be explained as including the preferred embodiments and all variations and modifications falling within the scope of the embodiments of the present application.

Finally, it should be further noted that, herein, the relation terms such as first and second are merely used to distinguish one entity or operation from another entity or operation, but do not require or imply such an actual relation or sequence between the entities or operations. Moreover, the terms “include”, “comprise” or other variations thereof are intended to cover non-exclusive inclusion, so that a process, method, article or terminal device including a series of elements not only includes the elements, but also includes other elements not clearly listed, or further includes inherent elements of the process, method, article or terminal device. In the absence of further limitations, an element defined by “including a/an . . . ” does not exclude other similar elements existing in the process, method, article or terminal device in which the element is included.

A data snapshot acquisition method and system provided in the present application are described in detail above, and the principles and implementation manners of the present application are described by using specific examples herein. The above description of the embodiments are merely used to help understand the method of the present application and core ideas thereof. Meanwhile, for those of ordinary skill in the art, there may be modifications to the specific implementation manners and application scopes according to the idea of the present application. Therefore, the content of the specification should not be construed as a limitation to the present application.

1. A data snapshot acquisition method, comprising:
acquiring a data change record on the basis of a redo log file started from a position and recorded in a source end;
loading the data change record to a destination end; and
acquiring, in the destination end, a first data snapshot corresponding to a preset time according to the data change record, when the preset time arrives.

2. The method according to claim 1, further comprising:
organizing, in response to a previously-acquired second data snapshot being at the position, the first data snapshot and the second data snapshot into a third data snapshot of the preset time.

3. The method according to claim 1, further comprising:
adding tag information to the data change record when the data change record is loaded to the destination end.

4. The method according to claim 3, wherein the data change record includes a primary key identifier, and acquiring, in the destination end, a first data snapshot corresponding to a preset time according to the data change record, when the preset time arrives further comprises:
detecting the tag information in the destination end;
determining whether the preset time has arrived;
reversely sorting the data change records of each primary key identifier if the preset time has arrived; and
acquiring a first sequential data record of each primary key identifier as a first data snapshot of the primary key identifier.

5. The method according to claim 4, wherein the data change record further comprises a data number, and reversely sorting the data change records of each primary key identifier if the preset time has arrived further comprises:
reversely sorting the data change record of each primary key identifier according to the data numbers if the preset time has arrived.

6. The method according to claim 1, wherein loading the data change record to a destination end further comprises:
publishing the data change record to a preset subscriber by a preset publisher, wherein the subscriber is configured to subscribe to the data change record from the publisher;
transforming, by the subscriber, the data change record to a data format required by the destination end; and
loading, by the subscriber, the data change record in the transformed data format to a data table of the destination end.

7. The method according to claim 6, wherein the data change record comprises a source end change timestamp, and loading, by the subscriber, the data change record in the transformed data format to a data table of the destination end further comprises:
determining, by the subscriber, a storage partition to which the data change record belongs according to the source end change timestamp of each data change record, wherein the storage partition includes a storage partition identifier; and
writing the data change record into the storage partition, and writing the identifier corresponding to the storage partition into a position corresponding to the data change record in the data table.

8. The method according to claim 1, further comprising:
storing data change records within a preset time period.

9. The method according to claim 6, wherein acquiring a data change record on the basis of a redo log file recorded in a source end further comprises:
collecting redo log files started from a specified position and recorded in a plurality of source ends into the publisher in a centralized way; and
parsing the redo log files by using the publisher to obtain corresponding data change records.

10. The method according to claim 2, wherein the first data snapshot comprises a first primary key identifier, a change type, and first numerical information, the second data snapshot comprises a second primary key identifier and second numerical information, and organizing the first data snapshot and the second data snapshot into a third data snapshot of the preset time further comprises:
merging the first data snapshot and the second data snapshot according to the first primary key identifier and/or the second primary key identifier; and
organizing the second primary key identifier and the second numerical information into a third data snapshot if the first primary key identifier is null, or organizing the first primary key identifier and the first numerical information into a third data snapshot if the first primary key identifier is not null.

11. A data snapshot acquisition system, comprising:
a data record acquisition module, configured to acquire a data change record on the basis of a redo log file started from a position and recorded in a source end;
a data loading module, configured to load the data change record to a destination end; and
a snapshot acquisition module, configured to acquire, in the destination end, a first data snapshot corresponding to a preset time according to the data change record, when the preset time arrives.

12-20. (canceled)

21. A non-transitory computer readable medium that stores a set of instructions that is executable by at least one processor of an electronic device to cause the electronic device to perform a data snapshot acquisition method, the method comprising:
acquiring a data change record on the basis of a redo log file started from a position and recorded in a source end;
loading the data change record to a destination end; and
acquiring, in the destination end, a first data snapshot corresponding to a preset time according to the data change record, when the preset time arrives.

22. The non-transitory computer readable medium according to claim 21, wherein the set of instructions is executable by at least one processor of an electronic device to cause the electronic device to further perform:
organizing, in response to a previously-acquired second data snapshot being at the position, the first data snapshot and the second data snapshot into a third data snapshot of the preset time.

23. The non-transitory computer readable medium according to claim 21, wherein the set of instructions is executable by at least one processor of an electronic device to cause the electronic device to further perform:
adding tag information to the data change record when the data change record is loaded to the destination end.

24. The non-transitory computer readable medium according to claim 23, wherein the data change record includes a primary key identifier, and wherein the set of instructions is executable by at least one processor of an electronic device to cause the electronic device to further perform acquiring, in the destination end, a first data snapshot corresponding to a preset time according to the data change record, when the preset time arrives by:
detecting the tag information in the destination end;
determining whether the preset time has arrived;
reversely sorting the data change records of each primary key identifier if the preset time has arrived; and
acquiring a first sequential data record of each primary key identifier as a first data snapshot of the primary key identifier.

25. The non-transitory computer readable medium according to claim 24, wherein the data change record further comprises a data number, and wherein the set of instructions is executable by at least one processor of an electronic device to cause the electronic device to further perform reversely sorting the data change records of each primary key identifier if the preset time has arrived by:
reversely sorting the data change record of each primary key identifier according to the data numbers if the preset time has arrived.

26. The non-transitory computer readable medium according to claim 21, wherein the set of instructions is executable by at least one processor of an electronic device to cause the electronic device to further perform loading the data change record to a destination end by:
publishing the data change record to a preset subscriber by a preset publisher, wherein the subscriber is configured to subscribe to the data change record from the publisher;
transforming, by the subscriber, the data change record to a data format required by the destination end; and
loading, by the subscriber, the data change record in the transformed data format to a data table of the destination end.

27. The non-transitory computer readable medium according to claim 26, wherein the data change record comprises a source end change timestamp, and the set of instructions is executable by at least one processor of an electronic device to cause the electronic device to further perform loading, by the subscriber, the data change record in the transformed data format to a data table of the destination end by:
determining, by the subscriber, a storage partition to which the data change record belongs according to the source end change timestamp of each data change record, wherein the storage partition includes a storage partition identifier; and
writing the data change record into the storage partition, and writing the identifier corresponding to the storage partition into a position corresponding to the data change record in the data table.

28. The non-transitory computer readable medium according to claim 21, wherein the set of instructions is executable by at least one processor of an electronic device to cause the electronic device to further perform:
storing data change records within a preset time period.

29. The non-transitory computer readable medium according to claim 26, wherein the set of instructions is executable by at least one processor of an electronic device to cause the electronic device to further perform acquiring a data change record on the basis of a redo log file recorded in a source end by:
collecting redo log files started from a specified position and recorded in a plurality of source ends into the publisher in a centralized way; and
parsing the redo log files using the publisher to obtain corresponding data change records.

30. The non-transitory computer readable medium according to claim 22, wherein the first data snapshot comprises a first primary key identifier, a change type, and first numerical information, the second data snapshot comprises a second primary key identifier and second numerical information, and the set of instructions is executable by at least one processor of an electronic device to cause the electronic device to further perform organizing the first data snapshot and the second data snapshot into a third data snapshot of the preset time by:
merging the first data snapshot and the second data snapshot according to the first primary key identifier and/or the second primary key identifier; and
organizing the second primary key identifier and the second numerical information into a third data snapshot if the first primary key identifier is null, or organizing the first primary key identifier and the first numerical information into a third data snapshot if the first primary key identifier is not null.
